(19) United States
(12) Patent Application Publication
(10) Pub. No.: US 2021/0075844 A1
(43) Pub. Date: Mar. 11, 2021

(54) INFORMATION PROCESSING DEVICE, INFORMATION PROCESSING METHOD, AND STORAGE MEDIUM

(71) Applicant: NEC CORPORATION, Tokyo (JP)

(72) Inventors: Takeshi ARIKUMA, Tokyo (JP); Takatoshi KITANO, Tokyo (JP)

(73) Assignee: NEC CORPORATION, Tokyo (JP)

(21) Appl. No.: 16/763,411

(22) PCT Filed: Nov. 13, 2018
(86) PCT No.: PCT/JP2018/042005

§ 371 Date: May 12, 2020

(30) Foreign Application Priority Data
Nov. 17, 2017 (JP) 2017-221496

(51) Int. Cl. H04L 29/06; G06K 9/00; G06K 9/62

(52) U.S. Cl. CPC H04L 65/80; G06K 9/6298; G06K 9/00771; H04L 65/4069

(57) ABSTRACT

An information processing device includes: a statistics unit that calculates an input data amount within a predetermined period for stream data which is divided into a plurality of divided data and on which distributed processing is performed; and a determination unit that determines a divided duration of the stream data based on the input data amount so that the number of times of transfer of the divided data between a plurality of nodes when the distributed processing is performed by the plurality of nodes satisfies a predetermined condition.

### TECHNICAL FIELD

The present invention relates to an information processing device, an information processing method, and a storage medium.

### BACKGROUND ART

Patent Literature 1 discloses an information processing device that performs a fast analysis process on stream data input in time series. This device temporally divides stream data so that respective ranges of stream data partially overlap with each other, causes a plurality of nodes to process the divided data in parallel, and thereby enables a fast analysis process while suppressing data transfer between the plurality of nodes.

### CITATION LIST

### Patent Literature

PTL 1: Japanese Patent Application Laid-open No. 2006-252394

### SUMMARY OF INVENTION

### Technical Problem

In Patent Literature 1, however, since stream data is divided so as to partially overlap with each other, the amount of data to be processed increases. Since a processing speed may be reduced in a case of a particular overlapping width, it is not always easy to suitably determine the divided width of the stream data.

The present invention has been made in view of the problem described above and intends to provide an information processing device, an information processing method, and a storage medium that can suitably determine a divided width of stream data when the stream data is divided and processed in a distributed manner.

### Solution to Problem

According to one example aspect of the present invention, provided is an information processing device including: a statistics unit that calculates an input data amount within a predetermined period for stream data which is divided into a plurality of divided data and on which distributed processing is performed; and a determination unit that determines a divided duration of the stream data based on the input data amount so that the number of times of transfer of the divided data between a plurality of nodes when the distributed processing is performed by the plurality of nodes satisfies a predetermined condition.

According to another example aspect of the present invention, provided is an information processing method including: calculating an input data amount within a predetermined period for stream data which is divided into a plurality of divided data and on which distributed processing is performed; and determining a divided duration of the stream data based on the input data amount so that the number of times of transfer of the divided data between a plurality of nodes when the distributed processing is performed by the plurality of nodes satisfies a predetermined condition.

According to another example aspect of the present invention, provided is a storage medium storing a program that causes a computer to perform: calculating an input data amount within a predetermined period for stream data which is divided into a plurality of divided data and on which distributed processing is performed; and determining a divided duration of the stream data based on the input data amount so that the number of times of transfer of the divided data between a plurality of nodes when the distributed processing is performed by the plurality of nodes satisfies a predetermined condition.

According to another example aspect of the present invention, provided is an information processing device including: a statistics unit that, for stream data which is divided into a plurality of divided data including first data and second data subsequent to the first data and on which distributed processing is performed, calculates a first input data amount within a predetermined period after the first data is divided, and a determination unit that determines a divided duration of the second data based on the first input data amount, and for the stream data, when a second input data amount within the predetermined period after the first data is divided and before the second data is divided increases above a predetermined threshold from the first input data amount, the determination unit reduces the divided duration.

According to another example aspect of the present invention, provided is an information processing method including: for stream data which is divided into a plurality of divided data including first data and second data subsequent to the first data and on which distributed processing is performed, calculating a first input data amount within a predetermined period after the first data is divided, and determining a divided duration of the second data based on the first input data amount, and for the stream data, when a second input data amount within the predetermined period after the first data is divided and before the second data is divided increases above a predetermined threshold from the first input data amount, the step of determining includes a step of reducing the divided duration.

According to another example aspect of the present invention, provided is a storage medium storing a program that causes a computer to perform an information processing method including: for stream data which is divided into a plurality of divided data including first data and second data subsequent to the first data and on which distributed processing is performed, calculating a first input data amount within a predetermined period after the first data is divided, and determining a divided duration of the second data based on the first input data amount, and for the stream data, when a second input data amount within the predetermined period after the first data is divided and before the second data is divided increases above a predetermined threshold from the first input data amount, the step of determining includes a step of reducing the divided duration.

### Advantageous Effects of Invention

According to the present invention, an information processing device, an information processing method, and a storage medium that can suitably determine a divided width of stream data when the stream data is divided and processed in a distributed manner are provided.

### BRIEF DESCRIPTION OF DRAWINGS

FIG. 1 is a schematic diagram of a surveillance system according to a first example embodiment.

FIG. 2 is a block diagram of an anomaly detection device according to the first example embodiment.

FIG. 3 is one example of content history information according to the first example embodiment.

FIG. 4 is one example of content statistics information according to the first example embodiment.

FIG. 5 is one example of division information according to the first example embodiment.

FIG. 6 is one example of allocation information according to the first example embodiment.

FIG. 7 is a hardware block diagram of the anomaly detection device according to the first example embodiment.

FIG. 8 is one example of image data according to the first example embodiment.

FIG. 9 is a schematic diagram of stream data according to the first example embodiment.

FIG. 10A is a conceptual diagram of division of stream data according to the first example embodiment.

FIG. 10B is a conceptual diagram of division of stream data according to the first example embodiment.

FIG. 11 is a table illustrating a relationship between division methods and delays according to the first example embodiment.

FIG. 12 is a flowchart illustrating the operation of the anomaly detection device according to the first example embodiment.

FIG. 13 is a detailed flowchart of a divided width determination process according to the first example embodiment.

FIG. 14 is a graph illustrating a divided width for each stream data according to the first example embodiment.

FIG. 15 is a graph illustrating a history of a divided width according to the first example embodiment.

FIG. 16 is a schematic configuration diagram of an information processing device according to a second example embodiment.

### DESCRIPTION OF EMBODIMENTS

### First Example Embodiment

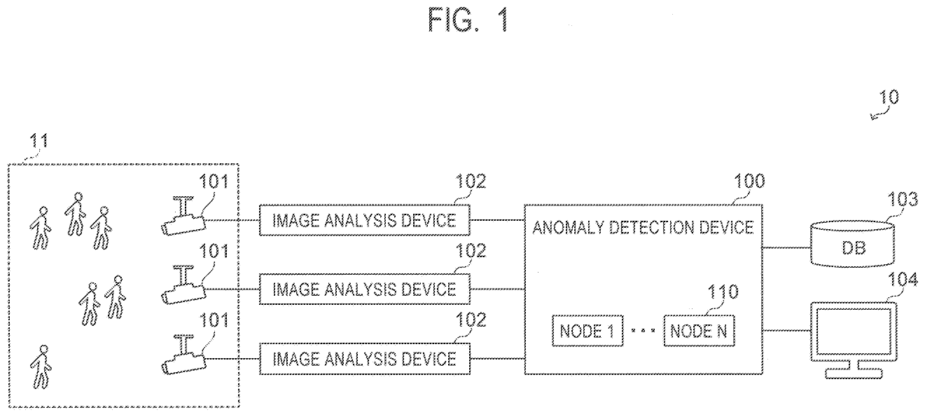

FIG. 1 is a schematic diagram of a surveillance system according to the present example embodiment. A surveillance system 10 is a system for finding a suspicious person in real time, for example, and preventing a crime and includes surveillance cameras 101, image analysis devices 102, an anomaly detection device 100, a database (DB) 103, and a surveillance terminal 104. The surveillance camera 101 is installed in a monitoring section 11 in which people comes and goes, such as an airport, a station, a shopping mall, or the like, and performs capturing of image data (moving image data) at a predetermined framerate. The number of surveillance cameras 101 is not limited, and around several hundreds to several thousands of surveillance cameras 101 may be installed within a single monitoring section 11.

The surveillance camera 101 includes an image capture device, an analog-to-digital (A/D) converter circuit, and an image processing circuit. The surveillance camera 101 can generate moving image data encoded in a predetermined format by converting an analog image signal obtained from the image capture device into digital RAW data and performing predetermined image processing on the RAW data.

The image analysis device 102 analyzes the content of moving image data from the surveillance camera 101 in real time and outputs information obtained by the analysis. For example, the image analysis device 102 can extract a subject (a person, an object, or the like) from moving image data and generate subject information. The subject information includes information on the number of subjects, a traffic line of each subject, or a feature amount (the orientation of a face or the like) of each subject. For example, a traffic line is expressed by a coordinate sequence indicating positions of a subject at each time by using spatial coordinates set within the monitoring section 11. The subject information continuously generated by the image analysis device 102 is input to the anomaly detection device 100 as stream data.

Note that, although the image analysis devices 102 are provided for each surveillance camera 101 in the present example embodiment, the example embodiment is not limited to this configuration. The image analysis device 102 may be any device that can analyze moving image data obtained from each of the surveillance cameras 101 in real time and output the analysis result to the anomaly detection device 100 as stream data. For example, a single image analysis device 102 may perform analysis on multiple types of moving image data obtained from the plurality of surveillance cameras 101. Alternatively, the image analysis device 102 may be formed integrally with the surveillance camera 101 or the anomaly detection device 100.

The anomaly detection device 100 uses stream data input from the image analysis device 102 to perform an analysis process having a high real-time property. For example, based on the input subject information, the anomaly detection device 100 can immediately (for example, within 5 seconds) detect a subject behaving abnormally. The analysis process is performed at the nodes 110 included in the anomaly detection device 100. The anomaly detection device 100 includes a plurality of nodes 110 and can perform an analysis process while maintaining a real-time property even with a large amount of stream data by performing distributed processing on the stream data by using the plurality of nodes 110. Note that the plurality of nodes 110 may be provided separately from the anomaly detection device 100 or may be formed of a plurality of cloud servers or the like arranged on a network. The anomaly detection device 100 is one example embodiment of the information processing device to which the present invention is applied.

The database 103 is provided in a hard disk, a storage server, or the like and stores a result of analysis performed by the anomaly detection device 100. The surveillance terminal 104 is a personal computer, a surveillance server, or the like and notifies a user (a surveillant) of an alert based on an analysis result from the anomaly detection device 100 and displays position information of the detected subject or the like. This enables a security guard or the like to hurry to the site and prevent a crime. The database 103 and the surveillance terminal 104 are connected to the anomaly detection device 100 directly or via a network.

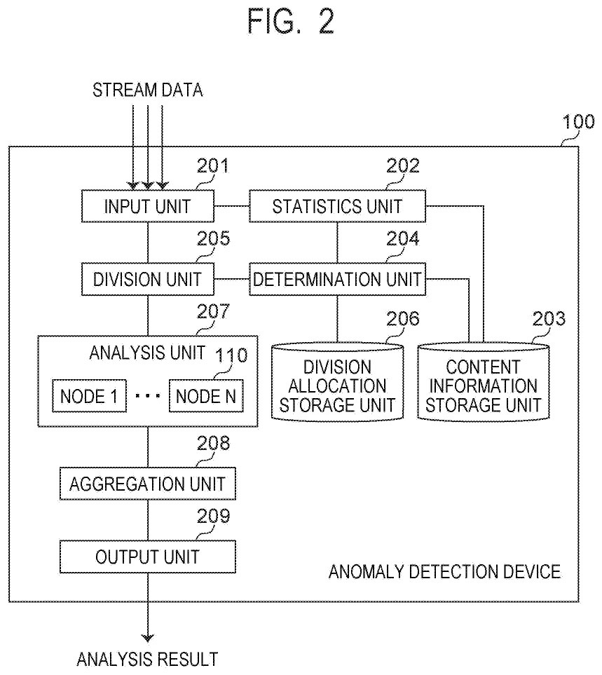

FIG. 2 is a block diagram of the anomaly detection device 100 according to present example embodiment. The anomaly detection device 100 includes an input unit 201, a statistics unit 202, a content information storage unit 203, a determination unit 204, a division unit 205, a division allocation storage unit 206, an analysis unit 207, an aggregation unit 208, and an output unit 209.

The input unit 201 receives stream data to be analyzed from the outside of the anomaly detection device 100. The input unit 201 can simultaneously receive a plurality of stream data from different image analysis devices 102.

The statistics unit 202 calculates an input data amount within a predetermined period for each stream data that have been input to the input unit 201. For example, a data amount of stream data per unit time is calculated. Furthermore, the statistics unit 202 calculates statistics information on the content of stream data input within a predetermined period. Once subject information is input as stream data, an average value, a 90%-tile value, a variation range, and the like are calculated as statistics information for the number of subjects included in subject information, and a period in which each subject is continuously included (that is, a duration from frame-in to frame-out of each subject). When the stream data is subject information, since the input data amount of stream data can be considered to be proportional to the number of subjects, the number of subjects can be used as an input data amount.

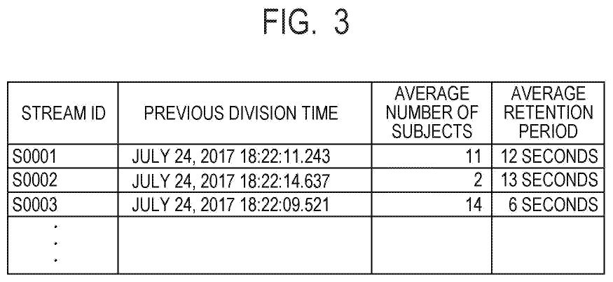

The content information storage unit 203 stores information calculated by the statistics unit 202 as content history information and content statistics information. First, FIG. 3 illustrates one example of the content history information. The content history information is the past statistics information calculated for already divided stream data and includes a stream ID, the previous division time, the average number of subjects, or the average retention period. The stream ID is a symbol used for identifying stream data. The previous division time is the time when stream data is previously (that is, the most recently) divided and is expressed in a unit of year, month, and date, hour, minute, and second, and one hundredth seconds. The average number of subjects is the average value of the number of subjects per unit time included in a predetermined period. The average retention period is the average value of retention periods of respective subjects included within a predetermined period.

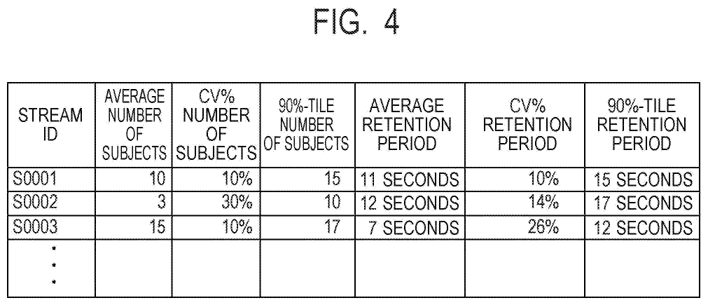

Next, FIG. 4 illustrates one example of content statistics information. The content statistics information is statistics information calculated from stream data that is being currently input before division and includes a stream ID, an average number of subjects, a CV % number of subject, a 90%-tile number of subject, an average retention period, a CV % retention period, or a 90%-tile retention period. The stream ID is a symbol used for identifying stream data and is the same as the stream ID of content history information. The average number of subjects is the average value of the number of subjects per unit time included in a predetermined period. The CV % number of subject represents a coefficient of variation of the number of subjects. The coefficient of variation is a value obtained by dividing a standard deviation by an average value and is used for evaluating variation of data. The 90%-tile number of subject represents the number of subjects located at 90% point (10% point from the top) when the overall distribution of the number of subjects is defined as 100%. The average retention period is the average value of retention periods of respective subjects included within a predetermined period. The CV % retention period represents a coefficient of variation of retention periods. The 90%-tile retention period represents the retention period located at 90% point (10% point from the top) when the overall distribution of retention periods is defined as 100%.

The determination unit 204 determines an increase rate a of a divided width of each stream data based on statistics information calculated by the statistics unit 202. The determination unit 204 determines a larger increase rate a for stream data having a relatively larger number of subjects out of all the stream data that have been input to the input unit 201. Furthermore, the determination unit 204 determines a divided width of each stream data. The divided width is a divided duration defined by time. The determination unit 204 calculates the number of times of transfer between the plurality of nodes 110 required when divided stream data (divided data) is processed at the plurality of nodes 110 in a distributed manner and determines a divided width based on statistics information (for example, the number of subjects) so that the number of times of transfer satisfies a predetermined condition. The divided width of the current divided data (second data) is calculated based on the divided width of the past divided data (first data). For example, for each stream data, the initial divided width is first determined, and the second and subsequent divided widths are calculated by multiplying the previous divided widths by the increase rate a.

The determination unit 204 gradually increases the divided width in accordance with the increase rate a when the number of subjects is stable (that is, a sharp increase or decrease of the number of subjects is not predicted). Thereby, it is possible to reduce the number of times of transfer that may occur between the plurality of nodes 110 and reduce a delay due to transfer (transfer delay) of distributed processing. On the other hand, the determination unit 204 reduces the divided width to the minimum value when a sharp increase of the number of subjects, that is, a sharp increase of the data amount is predicted. Thereby, it is possible to suppress a load overflow, which means that processing of divided data is not completed within a predetermined processing period in distributed processing, and prevent a delay due to a load overflow.

The division unit 205 generates divided data by dividing each stream data input to the input unit 201 in accordance with the divided width of each stream determined by the determination unit 204. The division unit 205 determines the node 110 to which divided data is allocated and transmits the divided data to the analysis unit 207 together with information on the allocating node. The division unit 205 can always output, to the analysis unit 207, stream data that have been input to the input unit 201 and switch where to output the stream data in the analysis unit 207 out of the plurality of nodes 110 at a timing in accordance with the divided width.

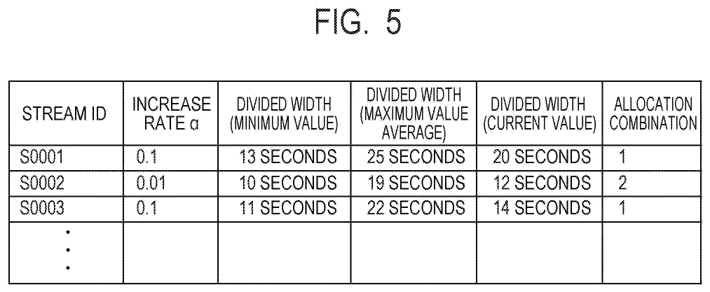

The division allocation storage unit 206 stores information determined by the determination unit 204 as division information and allocation information. First, FIG. 5 illustrates one example of division information. The division information is information regarding divided data and includes items of the stream ID, the increase rate a, the divided width, and the allocation combination. The divided width includes three types of values, namely, the minimum value, the average maximum value, and the current value. The stream ID is a symbol used for identifying stream data and is the same as the stream ID of FIG. 3 and FIG. 4. The increase rate a is an increase rate of the current divided width to the previous divided width. The divided width (the minimum value) is the minimum value of a divided width set so as to suppress a load overflow. The divided width (the average maximum value) is the average value of the maximum values within the past certain period when the divided width immediately before the divided width is reduced to the minimum value is defined as the maximum value for each stream. The divided width (current value) is a divided width currently used, and the divided data is generated in accordance with this value. The allocation combination represents a combination of allocating nodes of divided data when distributed processing is performed. Divided data of stream data having the same allocation combination is allocated to the same node 110.

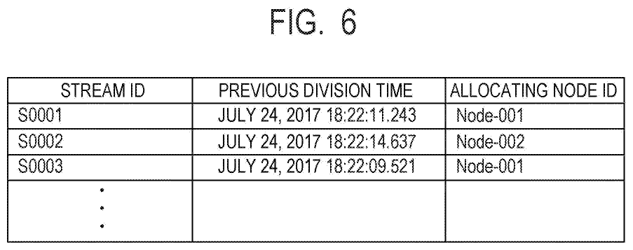

Next, FIG. 6 illustrates one example of allocation information. The allocation information is information regarding an allocating node of divided data and includes a stream ID, the previous division time, and an allocating node ID. The stream ID is a symbol used for identifying stream data and is the same as the stream ID of FIG. 3 to FIG. 5. The previous division time is the same as the previous division time of FIG. 3. The allocating node ID is a symbol used for identifying the node 110 to which divided data is allocated.

The analysis unit 207 includes the plurality of nodes 110 used for performing distributed processing and a control unit (not illustrated) used for controlling the plurality of nodes 110. One or a plurality of different divided data are allocated to each node 110, and each node 110 performs an analysis process of the allocated divided data. Each node 110 outputs an analysis result obtained by an analysis process to the aggregation unit 208. The analysis result represents information on a subject whose suspicious behavior is detected, for example.

The aggregation unit 208 aggregates respective analysis results output from the plurality of nodes 110 to create stream data of the analysis results (analysis result stream) for each stream data. The output unit 209 transmits an analysis result stream from the aggregation unit 208 to an external device such as the database 103, the surveillance terminal 104, or the like.

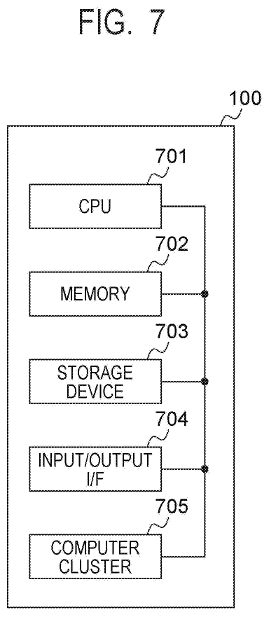

FIG. 7 is a hardware block diagram of the anomaly detection device 100 according to the present example embodiment. The anomaly detection device 100 includes a CPU 701, a memory 702, a storage device 703, an input/output interface (I/F) 704, and a computer cluster 705. The CPU 701 has a function of performing a predetermined operation in accordance with a program stored in the memory 702 or the storage device 703 and controlling each component of the anomaly detection device 100. Further, the CPU 701 executes a program that implements the function of the input unit 201, the statistics unit 202, the determination unit 204, the division unit 205, the aggregation unit 208, and the output unit 209.

The memory 702 is formed of a random access memory (RAM) or the like and provides a memory area required for the operation of the CPU 701. Further, the memory 702 may be used as a buffer area that implements the function of the input unit 201 and the output unit 209. The storage device 703 is a flash memory, a solid state drive (SSD), a hard disk drive (HDD), or the like, for example, and provides a storage area that implements the function of the content information storage unit 203 and the division allocation storage unit 206.

The storage device 703 stores a basic program such as operating system (OS) used for operating the anomaly detection device 100, an application program used for performing an analysis process, or the like. The input/output interface 704 is a module that communicates with an external device based on a standard such as a Universal Serial Bus (USB), Ethernet (registered trademark), Wi-Fi (registered trademark), or the like. The computer cluster 705 is a system in which a plurality of computers or processors are coupled to each other and implements the function of the analysis unit 207.

Note that the hardware configuration illustrated in FIG. 7 is an example, and a device other than the above may be added, or some of the devices may not be provided. For example, some of the functions may be provided by another device via a network, or the function forming the present example embodiment may be distributed and implemented in a plurality of devices.

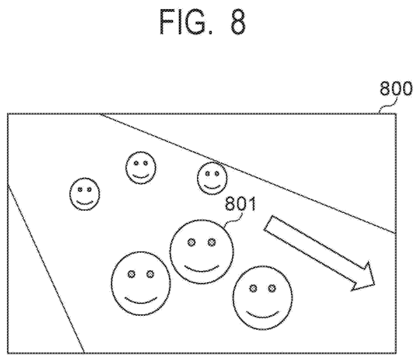

FIG. 8 is an example of image data according to the present example embodiment. This image data 800 corresponds to one frame of moving image data output from the surveillance camera 101. In this example, the surveillance camera 101 captures a one-way passage in an airport, the moving image data includes a view in which a plurality of subjects (persons) 801 are moving from the left back to the right front. In such a way, image data is a frame image representing a flow (motion) of one or more subjects such as a person or an automobile to be monitored.

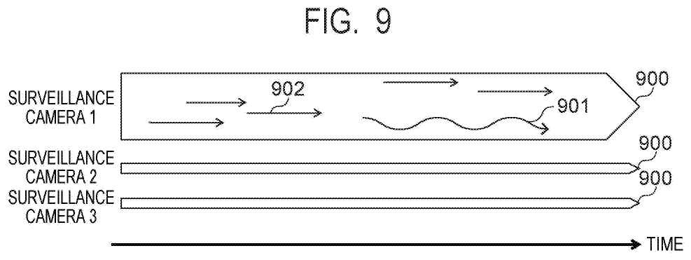

FIG. 9 is a conceptual diagram of stream data according to the present example embodiment. As described above, the stream data 900 is data representing an analysis result of moving image data captured by the surveillance camera 101 and is a coordinate sequence (time-series coordinates) representing a traffic line of each subject, for example. In FIG. 9, the traffic lines 901 and 902 of respective subjects are conceptually illustrated by using arrows. The traffic line 901 of a wavy line arrow indicates abnormal behavior such as staggering, retention, or the like inside the spatial coordinates, and the traffic line 902 of a straight line arrow indicates normal (that is, not abnormal) behavior. The purpose of an analysis process performed by the anomaly detection device 100 (more particularly, the analysis unit 207) is to detect the traffic line 901 indicating such abnormal behavior from the stream data 900.

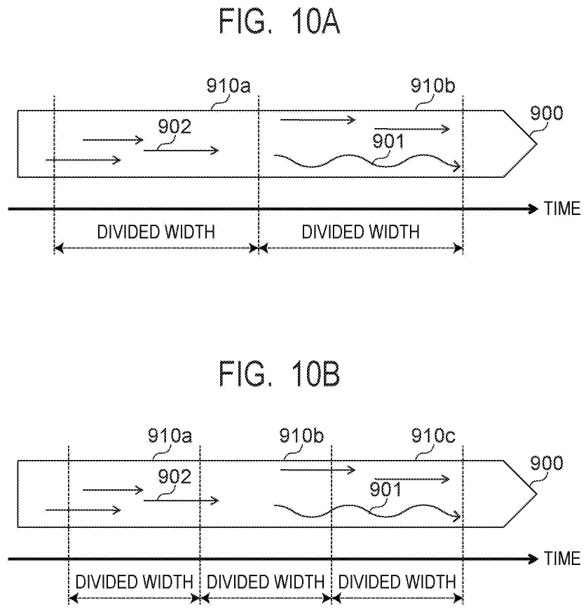

FIG. 10A and FIG. 10B are conceptual diagrams of division of stream data according to the present example embodiment. As described above, the anomaly detection device 100 (more particularly, the division unit 205) divides the stream data 900 into the plurality of divided data 910 and allocates each divided data 910 to any of the plurality of nodes 110. The divided width of the stream data 900 in FIG. 10B is smaller than the divided width of the stream data 900 in FIG. 10A.

Here, in focusing on the traffic line 901 indicating abnormal behavior, for example, the whole information on the traffic line 901 is included in a single divided data 910b in FIG. 10A. Therefore, the node 110 to which the divided data 910b is allocated can detect the traffic line 901 by an analysis process without acquiring information from another node 110.

In contrast, in FIG. 10B, the information on the traffic line 901 is divided into two divided data 910b and 910c. Therefore, the node 110 to which the divided data 910b is allocated (hereafter, referred to as a node 110b) can only detect the traffic line 901 partially. To detect the entire traffic line 901, the node 110b requires the divided data 910c to be transferred from another node 110 to which the divided data 910c is allocated. Further, also for the normal traffic line 902, transfer of the divided data 910 may be required as with the case of the traffic line 901.

As seen from the comparison between FIG. 10A and FIG. 10B, when the divided width of the stream data 900 is reduced, since information regarding the same subject such as the traffic line 901 or 902 is highly likely to be distributed to different nodes 110, the number of times of transfer of the divided data 910 increases between the plurality of nodes 110.

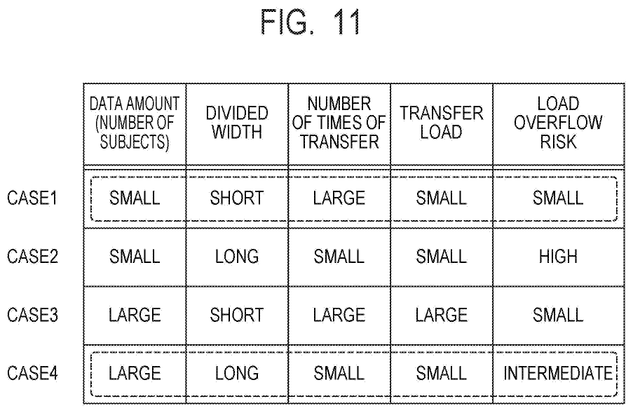

FIG. 11 is a table illustrating a relationship between division methods and delays according to the present example embodiment. This table indicates four cases for items of the data amount, the divided width, the number of times of transfer, the transfer load, and the load overflow risk. The data amount represents a data amount of the stream data 900, and the number of subjects per unit time is described here as a data amount. The divided width is a divided width of the stream data 900. The number of times of transfer is the number of times of transfer of the divided data 910 generated in distributed processing by using the plurality of nodes 110. The transfer load is a transfer load due to transfer of divided data 910. The load overflow risk represents the level of a probability that a load overflow occurs.

First, the case 1 is a case where the number of subjects is small and the divided width is short. In such a case, since the number of subjects included in the divided data 910 is small, the data transfer amount between the nodes 110 is also small. The data transfer amount here is expressed by bits per second (bps), for example. Although the number of times of transfer is large due to a short divided width, the degree of an increase in the transfer load is relatively low even when the number of times of transfer increases, and the transfer load is thus regarded to be small. Further, since the divided width is short, it is possible to early change an allocating node to another node in a situation where a load overflow occurs, and the load overflow risk is thus small.

The case 2 is a case where the number of subjects is small and the divided width is long. In such a case, as with the case 1, since the data transfer amount between the nodes 110 is small and the divided width is long, the number of times of transfer occurring between the nodes 110 is also small. Therefore, the transfer load is small. With respect to a load overflow, since the divided width is long, a load overflow is highly likely to be caused due to an increase in the number of subjects before the next division timing comes. In particular, when a state where the number of subjects is small transitions to a state where the number of subjects is large, since the load of an analysis process suddenly increases (for example, 10 to 20 times), a load overflow risk becomes extremely high. For example, when the surveillance camera 101 is set at an arrival lobby of an airport or the like, it is considered that the number of subjects sharply increases at arrival time of an airplane. It is therefore necessary to determine the divided width assuming that a sharp change of the number of subjects will occur.

The case 3 is a case where the number of subjects is large and the divided width is short. In such a case, since the number of subject is large, the data transfer amount between the nodes 110 is large. Further, since the divided width is short, the number of times of transfer occurring between the nodes 110 increases. Therefore, the transfer load is large. With respect to a load overflow, as with the case 1, it is possible to early change an allocating node to another node, and the load overflow risk is thus small.

The case 4 is a case where the number of subjects is large and the divided width is long. In such a case, since the number of subject is large, the data transfer amount between the nodes 110 is large. However, since the divided width is long and the number of times of transfer occurring between the nodes 110 decreases accordingly, the transfer load decreases as a whole. With respect to a load overflow, since the divided width is long, as with the case 2, a load overflow is highly likely to be caused due to an increase in the number of subjects. However, since there is a physical upper limitation in the number of subjects included in image data, the number of subjects does not sharply further increase from the state where the number of subjects is large. The increase in the load of an analysis process due to an increase in the number of subjects is assumed to be at most around two times, and the load overflow risk is at an intermediate level.

Given the above four cases, the case 1 and the case 4 are division methods in which a transfer load and a load overflow risk are balanced. Therefore, when determining the divided width of the stream data 900, it is preferable to reduce the divided width when the input data amount is smaller and increase the divided width when the input data amount is larger.

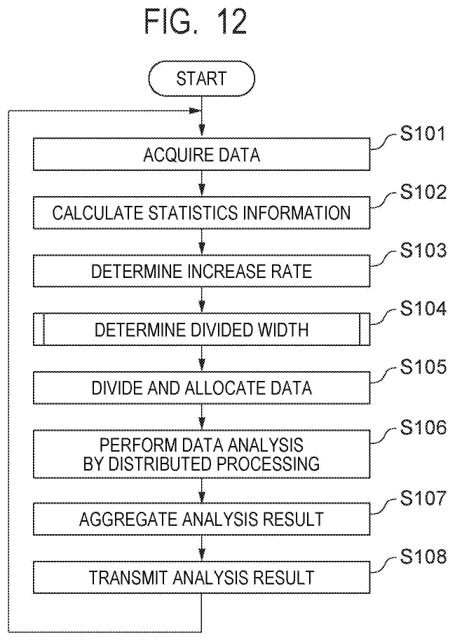

FIG. 12 is a flowchart illustrating the operation of the anomaly detection device according to the present example embodiment. First, the input unit 201 acquires the stream data 900 from the image analysis device 102 (step S101). Subsequently, the statistics unit 202 calculates statistics information on the content represented by the stream data 900 input to the input unit 201 (step S102). For example, the number of subjects included in the stream data 900 is calculated as the statistics information. The statistics unit 202 stores the calculated statistics information in the content information storage unit 203.

Next, the determination unit 204 determines the increase rate a of the divided width of the stream data 900 (step S103). Specifically, the increase rate a is calculated by the following Equation (1).

α=A*max (β, (1−divided width/maximum divided width)), β is a constant greater than or equal to 0 Equation (1)

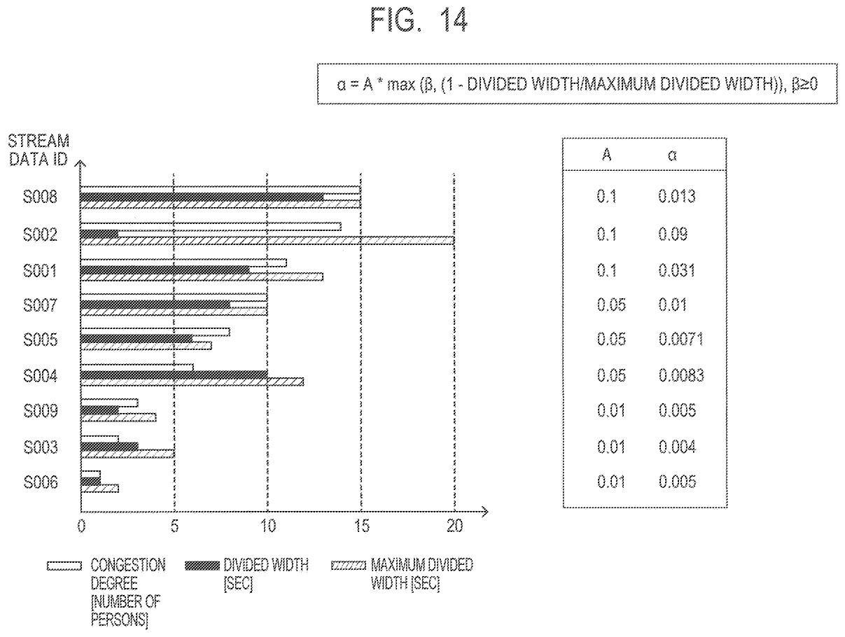

FIG. 14 illustrates one example of the calculated increase rate a and the fundamental increase ratio A used in calculation of the increase rate a. The table on the right side in FIG. 14 indicates the increase rate a and the fundamental increase rate A so as to correspond to the arrangement of stream data in the bar graphs on the left side for each of the plurality of stream data (S001 to S009). Each white bar graph, each black bar graph, and each diagonally hatched bar graph represent a congestion degree, a divided width, and a maximum divided width, respectively. The congestion degree is an index of an input data amount and represented by the average number of subjects, for example. The average number of subjects is stored in the content information storage unit 203, and the divided width and the maximum divided width are stored in the division allocation storage unit 206. Note that, in the initial state, that is, before the input of the stream data 900 is started, since neither the divided width nor the maximum divided width is stored in the division allocation storage unit 206, β in Equation (1) is required when the initial increase rate is calculated or the like.

The fundamental increase rate A is calculated in accordance with the congestion degree. For example, the fundamental increase rate A may be a value obtained by multiplying the congestion degree by a certain weight coefficient. Further, the stream data 900 may be ranked in accordance with the congestion degree, and the fundamental increase rate A may be set based on the rank. In the example of FIG. 14, the fundamental increase rate A is set based on the rank of the stream data 900. That is, the stream data that has been input is grouped into three groups of a higher level, a middle level, and a lower level, and the fundamental increase rate A is set to 0.1 for the stream data S008, S002, and S001 belonging to the higher level. Similarly, the fundamental increase rate A is set to 0.05 for the stream data S007, S005, and S004 belonging to the middle level, and the fundamental increase rate A is set to 0.01 for the stream data S009, S003, and S006 belonging to the lower level.

In such a way, when the fundamental increase rate A is set to be larger for a higher ranked (that is, a larger input data amount) stream data 900, the increase rate a tends to be set to be larger also for a larger input data amount. When the fundamental increase rate A is calculated in accordance with the congestion degree, the fundamental increase rate A of more stream data 900 will be calculated to be higher when the congestion degree of the most part of the stream data 900 is high, for example. Then, the divided width increases in accordance with the fundamental increase rate A, and as a result, a load overflow risk in distributed processing may significantly increase. In terms of the above, it is preferable to calculate the fundamental increase rate A in accordance with the rank.

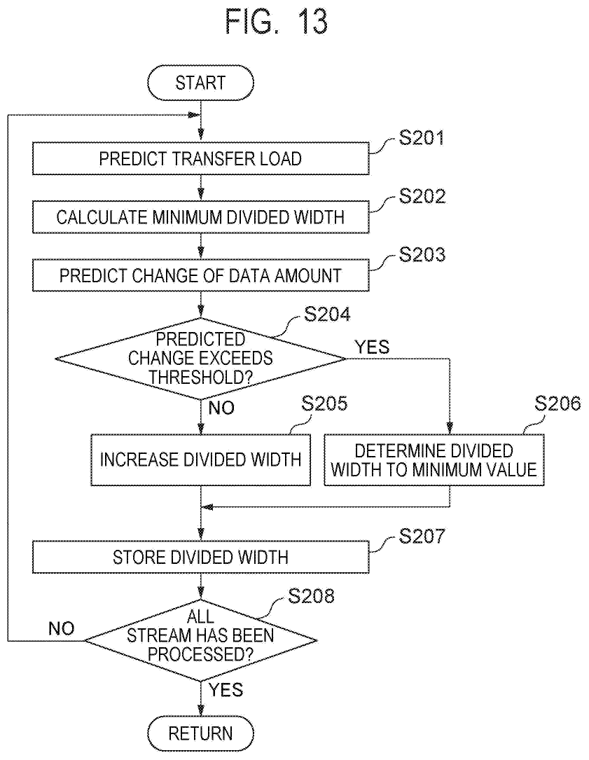

Next, the determination unit 204 determines the divided width of the stream data 900 (step S104). The divided width is determined for each of all the stream data 900 that have been input. Details of this process will be described later with reference to FIG. 13. Subsequently, the division unit 205 divides each stream data 900 in accordance with the divided width determined by the determination unit 204. The division unit 205 then allocates each divided data 910 generated by division to any of the plurality of nodes 110 of the analysis unit 207 (step S105).

Next, the analysis unit 207 performs data analysis by using distributed processing (step S106). That is, at the analysis unit 207, each node 110 performs an analysis process of the allocated divided data 910 and outputs an analysis result. For example, when the first node 110 performs an analysis process, the analysis unit 207 performs control so that the required divided data 910 is transferred from the second node 110 to the first node 110 when requiring the divided data 910 allocated to the second node 110.

Next, the aggregation unit 208 aggregates analysis results output from the analysis unit 207 (step S107). For example, pieces of anomaly detection information for all the stream data 900 that have been input are aggregated. Finally, the output unit 209 externally transmits the analysis result (step S108). For example, the output unit 209 stores the anomaly detection information in the database 103 and transmits the anomaly detection information to the surveillance terminal 104. At the surveillance terminal 104, alert notification, position display of a subject, or the like is performed based on the anomaly detection information.

FIG. 13 is a detailed flowchart of the divided width determination process (step S104) according to the present example embodiment. First, the determination unit 204 predicts transfer loads occurring between the plurality of nodes 110 based on statistics information for the stream data 900 to be processed (step S201). For example, the transfer load is calculated by multiplying the data amount of the divided data 910 by the number of times of transfer of the divided data 910. Here, the number of times of transfer can be acquired by using a table or a regression equation that predefines the number of times of transfer in accordance with a data amount and a divided width. Specifically, the determination unit 204 calculates multiple patterns of combinations of a temporary divided width and the number of times of transfer acquired from the table, the regression equation or the like described above by using the data amount and the temporary divided width and calculates the transfer load for each pattern. Furthermore, the determination unit 204 determines whether or not the transfer load satisfies a predetermined condition. The predetermined condition defines that the number of times of transfer is reduced (for example, to a predetermined number of times or less) as long as no load overflow occurs at the node 110, for example. Note that the number of times of transfer may be predicted from history data in which the correlation of the past data amount, the divided width, and the number of times of transfer is recorded or can be calculated by machine learning based on the history data.

Next, the determination unit 204 calculates the minimum divided width of the stream data 900 (step S202). In this step, the minimum divided width is set so as to satisfy a transfer delay required in distributed processing. Subsequently, the determination unit 204 predicts a change in the input data amount of the stream data 900 (step S203). For example, it is possible to calculate a future input data amount by extrapolation based on the past change of the input data amount. Instead of an input data amount, a process load amount may be calculated. The input data amount (or the process load amount) here means a data amount input per unit time (or required to be processed), for example.

The determination unit 204 may externally acquire prediction information of an input data amount. For example, the image analysis device 102 may analyze moving image data from the surveillance camera 101 to predict a change in the number of subjects, and the determination unit 204 may acquire prediction information from the image analysis device 102. With reference to FIG. 8 for illustration of one example of prediction, the image analysis device 102 can predict the number of subjects which frame in from the left back of the image data 800 and the number of subjects which frame out from the right front and calculate a change in the number of subjects based on the difference thereof. The number of subjects which frame in can be detected by using image data from another surveillance camera 101 that captures the outside of the angle of view of the image data 800, for example. Alternatively, when framing in of a group of subjects, individuals of which are not distinguished before coming closer, is detected in the back (on the far side) of a space captured by the surveillance camera 101, the number of subjects can be predicted based on a feature amount of the group of subjects.

Next, the determination unit 204 determines whether or not the predicted change amount exceeds a predetermined threshold (step S204). For example, the difference between an input data amount predicted at the time when the next division is performed and the current input data amount (that is, the input data amount calculated when the current divided width is determined) is compared with a threshold. If the change amount is less than or equal to the threshold (step S204, NO), the determination unit 204 increases the divided width of the stream data 900 (step S205) in accordance with the increase rate a determined in the increase rate determination process (step S103). In this step, the divided width is determined so that the transfer load satisfies the predetermined condition described above. On the other hand, if the change amount exceeds the threshold (step S204, YES), the determination unit 204 determines the divided width of the stream data 900 to the minimum divided width (minimum value) (step S206).

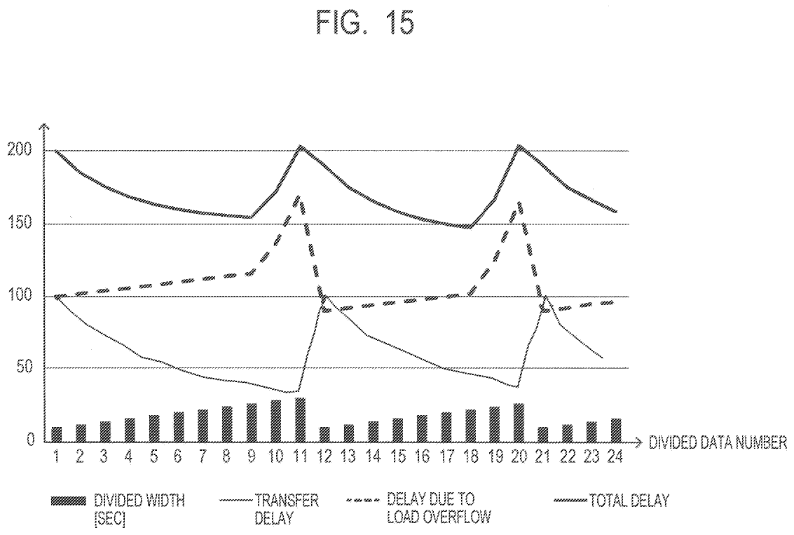

FIG. 15 illustrates one example of the history of the determined divided width. The horizontal axis of the graph represents numbers of the divided data 910 arranged in time series in division order. The vertical axis of the graph represents the duration of the divided data 910 and the delay time in the distributed processing. The solid line represents the delay due to transfer (transfer delay) of the divided data 910, and the thick dotted line represents the delay due to a load overflow (load delay). The load delay is a value at the future time predicted at the current time (for example, the time of the next division). The thick solid line represents the total delay of the transfer delay and the load delay.

As illustrated in the thick dotted line in FIG. 15, the predicted load delay gradually increases at the time corresponding to the division data numbers 1 to 9. This increase amount is less than or equal to a predetermined threshold. Since the change amount is less than or equal to the predetermined threshold, the determination unit 204 gradually increases the divided width by multiplying the previous divided width by the increase rate a. The predicted load delay sharply increases at the time corresponding to the divided data number 10. This increase amount exceeds the predetermined threshold.

Therefore, while the determination unit 204 may immediately reduce the divided width to the minimum value because the change amount exceeds the predetermined threshold, the determination unit 204 reduces the divided width to the minimum value when the change amount continuously exceeds the predetermined threshold in the example of FIG. 15. That is, since the predicted load delay continues to sharply increase also at the time corresponding to the divided data number 11, the determination unit 204 determines the divided width to the minimum value at this time. Subsequently, the same determination is performed for the divided width also at the time corresponding to the divided data numbers 12 to 20.

The determination unit 204 stores the determined divided width in the division allocation storage unit 206 (step S207). The determination unit 204 determines whether or not the divided width has been determined for all the stream data 900 that have been input (step S208). If the stream data 900 for which the divided width has not yet been determined remains (step S208, NO), the determination unit 204 selects the next stream data 900 to be processed and returns to step S201. If the divided width has been determined for all the stream data 900 (step S208, YES), the determination unit 204 returns to the process of the flowchart of FIG. 12.

According to the present example embodiment, based on an input data amount of stream data and the number of times of transfer of divided data occurring when the stream data is divided into divided data and distributed processing is performed at a plurality of nodes, the divided duration of the stream data is determined. Accordingly, a load overflow risk due to a large input data amount and a risk of a transfer delay due to an increased number of times of transfer can be balanced, and the divided width can be appropriately determined so that the delay in the whole distributed processing is reduced.

Further, according to the present example embodiment, when a sharp increase in an input data amount of stream data is predicted, since the divided width can be reduced in advance, the load overflow risk can be suppressed. This method of determining the divided width is suitable for a case such as when the influence of a delay due to a load overflow is much greater than the influence of a delay due to an increase of transfer and a load overflow is intended to be prevented as much as possible in distributed processing. [Second Example Embodiment]

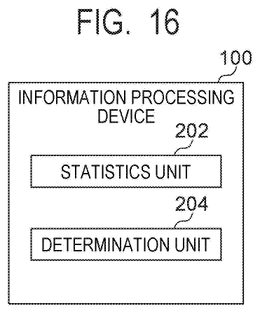

FIG. 16 is a schematic configuration diagram of an information processing device 100 according to the present example embodiment. The information processing device 100 includes the statistics unit 202 that calculates an input data amount within a predetermined period for the stream data 900 that is divided into a plurality of divided data 910 and on which distributed processing is performed and the determination unit 204 that determines a divided duration of the stream data 900 based on the input data amount so that the number of times of transfer of the divided data 910 between the plurality of nodes 110 satisfies a predetermined condition when the distributed processing is performed by the plurality of nodes 110.

### Modified Example Embodiments

The present invention is not limited to the example embodiments described above and can be changed as appropriate within the scope not departing from the spirit of the present invention. For example, although the stream data 900 is generated from moving image data in the example embodiments described above, the example embodiment is not limited thereto. For example, the stream data 900 may be individual moving image data as long as the input data amount varies as the time elapses and may be audio data, data input from multiple sensors, or the like other than the above. Further, the information processing device of the present invention is not limited to the anomaly detection device 100 but can be widely applied for an analysis target from which stream data occurs, such as stock price information in the stock exchange, usage information on a credit card, traffic information, or the like.

Further, the scope of each of the example embodiments includes a processing method that stores, in a storage medium, a program that causes the configuration of each of the example embodiments to operate so as to implement the function of each of the example embodiments described above, reads the program stored in the storage medium as a code, and executes the program in a computer. That is, the scope of each of the example embodiments also includes a computer readable storage medium. Further, each of the example embodiments includes not only the storage medium in which the program described above is stored but also the program itself. Further, one or more components included in the example embodiments described above may be a circuit such as an application specific integrated circuit (ASIC), a field programmable gate array (FPGA), or the like configured to implement the function of each component.

As the storage medium, for example, a floppy (registered trademark) disk, a hard disk, an optical disk, a magneto-optical disk, a compact disk (CD)-ROM, a magnetic tape, a nonvolatile memory card, or a ROM can be used. Further, the scope of each of the example embodiments includes an example that operates on operating system (OS) to perform a process in cooperation with another software or a function of an add-in board without being limited to an example that performs a process by an individual program stored in the storage medium.

The whole or part of the example embodiments disclosed above can be described as, but not limited to, the following supplementary notes.

### (Supplementary Note 1)

An information processing device comprising:

a statistics unit that calculates an input data amount within a predetermined period for stream data which is divided into a plurality of divided data and on which distributed processing is performed; and

a determination unit that determines a divided duration of the stream data based on the input data amount so that the number of times of transfer of the divided data between a plurality of nodes when the distributed processing is performed by the plurality of nodes satisfies a predetermined condition.

### (Supplementary Note 2)

The information processing device according to supplementary note 1, wherein the determination unit determines the divided duration to be longer for a larger transfer load calculated from the input data amount and the number of times of transfer.

### (Supplementary Note 3)

The information processing device according to supplementary note 1 or 2, wherein the determination unit determines the divided duration so that processing of the divided data by the nodes is completed within a predetermined processing period in the distributed processing.

### (Supplementary Note 4)

The information processing device according to any one of supplementary notes 1 to 3, wherein the plurality of divided data includes first data and second data subsequent to the first data, and the determination unit determines a divided duration of the second data based on a divided duration of the first data.

### (Supplementary Note 5)

The information processing device according to supplementary note 4, wherein the determination unit determines an increase rate of the divided duration of the second data to the divided duration of the first data.

### (Supplementary Note 6)

The information processing device according to supplementary note 5,

wherein the statistics unit calculates the input data amount for a plurality of different stream data, and

wherein the determination unit determines the increase rate to be larger for the stream data having a larger input data amount out of the plurality of stream data.

### (Supplementary Note 7)

The information processing device according to supplementary note 5 or 6, wherein the number of times of transfer is predicted in accordance with the divided duration of the second data or based on history data including the number of times of transfer of the first data.

### (Supplementary Note 8)

The information processing device according to any one of supplementary notes 1 to 7, wherein the stream data represents subject information detected from moving image data.

### (Supplementary Note 9)

The information processing device according to supplementary note 8, wherein the statistics unit calculates the number of subjects within the predetermined period included in the stream data from the subject information, and the input data amount is based on the number of subjects.

### (Supplementary Note 10)

The information processing device according to supplementary note 9, wherein the statistics unit calculates, from the subject information, a duration in which each subject is continuously included in the stream data, and the number of times of transfer is calculated based on the number of subjects and the duration time.

### (Supplementary Note 11)

An information processing method comprising:

calculating an input data amount within a predetermined period for stream data which is divided into a plurality of divided data and on which distributed processing is performed; and

determining a divided duration of the stream data based on the input data amount so that the number of times of transfer of the divided data between a plurality of nodes when the distributed processing is performed by the plurality of nodes satisfies a predetermined condition.

### (Supplementary Note 12)

A storage medium storing a program that causes a computer to perform:

calculating an input data amount within a predetermined period for stream data which is divided into a plurality of divided data and on which distributed processing is performed; and

determining a divided duration of the stream data based on the input data amount so that the number of times of transfer of the divided data between a plurality of nodes when the distributed processing is performed by the plurality of nodes satisfies a predetermined condition.

### (Supplementary Note 13)

An information processing device comprising:

a statistics unit that, for stream data which is divided into a plurality of divided data including first data and second data subsequent to the first data and on which distributed processing is performed, calculates a first input data amount within a predetermined period after the first data is divided, and a determination unit that determines a divided duration of the second data based on the first input data amount,

wherein for the stream data, when a second input data amount within the predetermined period after the first data is divided and before the second data is divided increases above a predetermined threshold from the first input data amount, the determination unit reduces the divided duration.

### (Supplementary Note 14)

An information processing method comprising:

for stream data which is divided into a plurality of divided data including first data and second data subsequent to the first data and on which distributed processing is performed, calculating a first input data amount within a predetermined period after the first data is divided, and determining a divided duration of the second data based on the first input data amount,

wherein for the stream data, when a second input data amount within the predetermined period after the first data is divided and before the second data is divided increases above a predetermined threshold from the first input data amount, the step of determining includes a step of reducing the divided duration.

### (Supplementary Note 15)

A storage medium storing a program that causes a computer to perform an information processing method including:

for stream data which is divided into a plurality of divided data including first data and second data subsequent to the first data and on which distributed processing is performed, calculating a first input data amount within a predetermined period after the first data is divided, and determining a divided duration of the second data based on the first input data amount,

wherein for the stream data, when a second input data amount within the predetermined period after the first data is divided and before the second data is divided increases above a predetermined threshold from the first input data amount, the step of determining includes a step of reducing the divided duration.

This application is based upon and claims the benefit of priority from Japanese Patent Application No. 2017-221496, filed on Nov. 17, 2017, the disclosure of which is incorporated herein in its entirety by reference.

### REFERENCE SIGNS LIST

10 surveillance system
11 monitoring section
100 anomaly detection device (information processing device)
101 surveillance camera
102 image analysis device
103 database
104 surveillance terminal
110 node
201 input unit
202 statistics unit
203 content information storage unit
204 determination unit
205 division unit
206 division allocation storage unit
207 analysis unit
208 aggregation unit
209 output unit
701 CPU
702 memory
703 storage device
704 input/output I/F
705 computer cluster
800 image data
801 subject
900 stream data
901, 902 traffic line
910 divided data

1. An information processing device comprising:
a statistics unit that calculates an input data amount within a predetermined period for stream data which is divided into a plurality of divided data and on which distributed processing is performed; and
a determination unit that determines a divided duration of the stream data based on the input data amount so that the number of times of transfer of the divided data between a plurality of nodes when the distributed processing is performed by the plurality of nodes satisfies a predetermined condition.

2. The information processing device according to claim 1, wherein the determination unit determines the divided duration to be longer for a larger transfer load calculated from the input data amount and the number of times of transfer.

3. The information processing device according to claim 1, wherein the determination unit determines the divided duration so that processing of the divided data by the nodes is completed within a predetermined processing period in the distributed processing.

4. The information processing device according to claim 1, wherein the plurality of divided data includes first data and second data subsequent to the first data, and the determination unit determines a divided duration of the second data based on a divided duration of the first data.

5. The information processing device according to claim 4, wherein the determination unit determines an increase rate of the divided duration of the second data to the divided duration of the first data.

6. The information processing device according to claim 5,
wherein the statistics unit calculates the input data amount for a plurality of different stream data, and
wherein the determination unit determines the increase rate to be larger for the stream data having a larger input data amount out of the plurality of stream data.

7. The information processing device according to claim 5, wherein the number of times of transfer is predicted in accordance with the divided duration of the second data or based on history data including the number of times of transfer of the first data.

8. The information processing device according to claim 1, wherein the stream data represents subject information detected from moving image data.

9. The information processing device according to claim 8, wherein the statistics unit calculates the number of subjects within the predetermined period included in the stream data from the subject information, and the input data amount is based on the number of subjects.

10. The information processing device according to claim 9, wherein the statistics unit calculates, from the subject information, a duration in which each subject is continuously included in the stream data, and the number of times of transfer is calculated based on the number of subjects and the duration time.

11. An information processing method comprising:
calculating an input data amount within a predetermined period for stream data which is divided into a plurality of divided data and on which distributed processing is performed; and
determining a divided duration of the stream data based on the input data amount so that the number of times of transfer of the divided data between a plurality of nodes when the distributed processing is performed by the plurality of nodes satisfies a predetermined condition.

12. A non-transitory storage medium storing a program that causes a computer to perform:
calculating an input data amount within a predetermined period for stream data which is divided into a plurality of divided data and on which distributed processing is performed; and
determining a divided duration of the stream data based on the input data amount so that the number of times of transfer of the divided data between a plurality of nodes when the distributed processing is performed by the plurality of nodes satisfies a predetermined condition.

13. An information processing device comprising:
a statistics unit that, for stream data which is divided into a plurality of divided data including first data and second data subsequent to the first data and on which distributed processing is performed, calculates a first input data amount within a predetermined period after the first data is divided, and a determination unit that determines a divided duration of the second data based on the first input data amount,
wherein for the stream data, when a second input data amount within the predetermined period after the first data is divided and before the second data is divided increases above a predetermined threshold from the first input data amount, the determination unit reduces the divided duration.

14. An information processing method comprising:
for stream data which is divided into a plurality of divided data including first data and second data subsequent to the first data and on which distributed processing is performed, calculating a first input data amount within a predetermined period after the first data is divided, and determining a divided duration of the second data based on the first input data amount,
wherein for the stream data, when a second input data amount within the predetermined period after the first data is divided and before the second data is divided increases above a predetermined threshold from the first input data amount, the step of determining includes a step of reducing the divided duration.

15. A non-transitory storage medium storing a program that causes a computer to perform an information processing method including:
for stream data which is divided into a plurality of divided data including first data and second data subsequent to the first data and on which distributed processing is performed, calculating a first input data amount within a predetermined period after the first data is divided, and determining a divided duration of the second data based on the first input data amount,
wherein for the stream data, when a second input data amount within the predetermined period after the first data is divided and before the second data is divided increases above a predetermined threshold from the first input data amount, the step of determining includes a step of reducing the divided duration.
